(19) United States
(12) Patent Application Publication
(10) Pub. No.: US 2008/0097840 A1
(43) Pub. Date: Apr. 24, 2008

(54) Mail advertising addressing system

(76) Inventor: David Lesniak, Bridgeport, NJ (US)

Correspondence Address: Anthony H. Handal;Brown Rudnick Berlack Israels LLP, One Financial Center, Boston, MA, 02111, US

(21) Appl. No.: 11/584,071

(22) Filed: Oct. 20, 2006

(51) Int. Cl. G06Q 30/00

(52) U.S. Cl. 705/14

(57) ABSTRACT

A method of manufacturing an advertising device comprising manufacturing an advertising device describing at least one attribute of at least one product or service is disclosed. A facility address is retrieved from a database of establishment locations the address of one or more facilities offering the product or service. In a recipient address of an intended advertising device recipient is retrieved from a database of advertising device recipients. A route between the facility address and the recipient address is generated. The route is then applied to the advertising device.

Direct response advertising, sometimes referred to as direct mail advertising, has long been used to solicit orders for all sorts of merchandise, ranging from shoes to automobiles. Generally, such advertising takes the form of mailings of catalogs, flyers, coupons, newspapers or the like to a group of recipients.

Recipients are identified through the assembly or purchase of a mailing list. Such mailing lists are available from companies whose specialty is providing the same. These lists may be based on professional association, location, economic strata, interest in particular products or services, and so forth. Generally, the techniques surrounding direct marketing activities are highly developed and scientific in nature.

For many years now, even long before the advent of the personal computer in the early 1980's, direct response mailing lists have been available in computer readable format, such as disks, tapes, and word processing files which may be sent over the Internet. Such electronically recorded lists allow labels to be repeatedly generated and, more frequently, also permit the direct application of an address to a catalog, envelope, mailer or the like.

Typically, in addition to an address being applied to a catalog, other information may also be applied. For example, the same may include various numbers which are used by the person who has sent out the catalog. Accordingly, if an individual places an order with a company in response to a catalog received from the company, the operator may often ask the individual to read certain numbers from the address label.

Notwithstanding in the popularity of direct response advertising and its effectiveness in generating telephone and mail-order sales, many products may be more easily sold, to many individuals by a conventional bricks and mortar retailer. Thus, many mailing pieces include information on, for example, the locations of retail stores operated by the company sending the mail order catalog. If the mailing is being done in a particular regional area, the stores listed may be limited to those in that regional area. However, many mailing pieces list stores countrywide often with a directory of states showing each retail location.

One of the problems with mail advertising is the relatively low rate of return. For example, rates of return of the order of 1% or 2% are often experienced. These for response rates mean that relatively high cost of manufacturing the mailer must be passed on to the consumer. This has the effect of creating upward pressure on prices, as those individuals purchasing products in response to the mail advertising, must pay for the cost of manufacture and distribution of old catalogs sent to persons who did not order products.

It has long been recognized that anything which will increase the likelihood of a positive response to mail advertising is of great value. Accordingly, mail advertisers have resorted to numerous artifices in order to improve response. These include enclosing plastic “credit cards”, checks, mimicking bank, credit card or other statements, “do not destroy” designations, and so forth.

### SUMMARY OF THE INVENTION

In accordance with the invention, a method of manufacturing an advertising device, comprises manufacturing an advertising device describing at least one attribute of at least one product or service. A facility address is retrieved from a database of establishment locations with the address of one or more facilities offering the product or service. A recipient address of an intended advertising device recipient is retrieved from a database of advertising device recipients. A route between the facility address and the recipient address is generated. The route is then applied to the advertising device.

The advertising device may be a catalog, coupon, gift, brochure, or flyer.

The facility address may be, for example, the address of a retail, professional, medical, legal services, sports, golf course, or gym establishment.

In accordance with a particularly preferred embodiment of the invention, previously determined routes are consulted before calculating a route for the purpose of eliminating calculation of a route or shortening the time for calculation of a route.

In accordance with a preferred embodiment of the invention, a driving route between the facility address and the recipient address is determined. Application of the route and/or map and address may be done by direct printing or by printing on a label which is adhered to the advertising device.

Such application may comprise applying the route in map form or as a set of driving directions.

In accordance with the invention, the advertising device is deposited in the mails with the route applied to it.

### BRIEF DESCRIPTION OF THE DRAWINGS

These and other objects of the invention will become apparent from the following description taken together in conjunction with the drawings, which only illustrate several embodiments of the invention, and in which:

FIG. 1 is a block diagram of the method process/software for practicing the method of the present invention;

FIG. 2 is a block diagram of an alternative embodiment of the inventive method process/software; and

FIG. 3 is a block diagram of a mother alternative embodiment of the inventive method process/software.

### DETAILED DESCRIPTION OF THE PREFERRED EMBODIMENTS

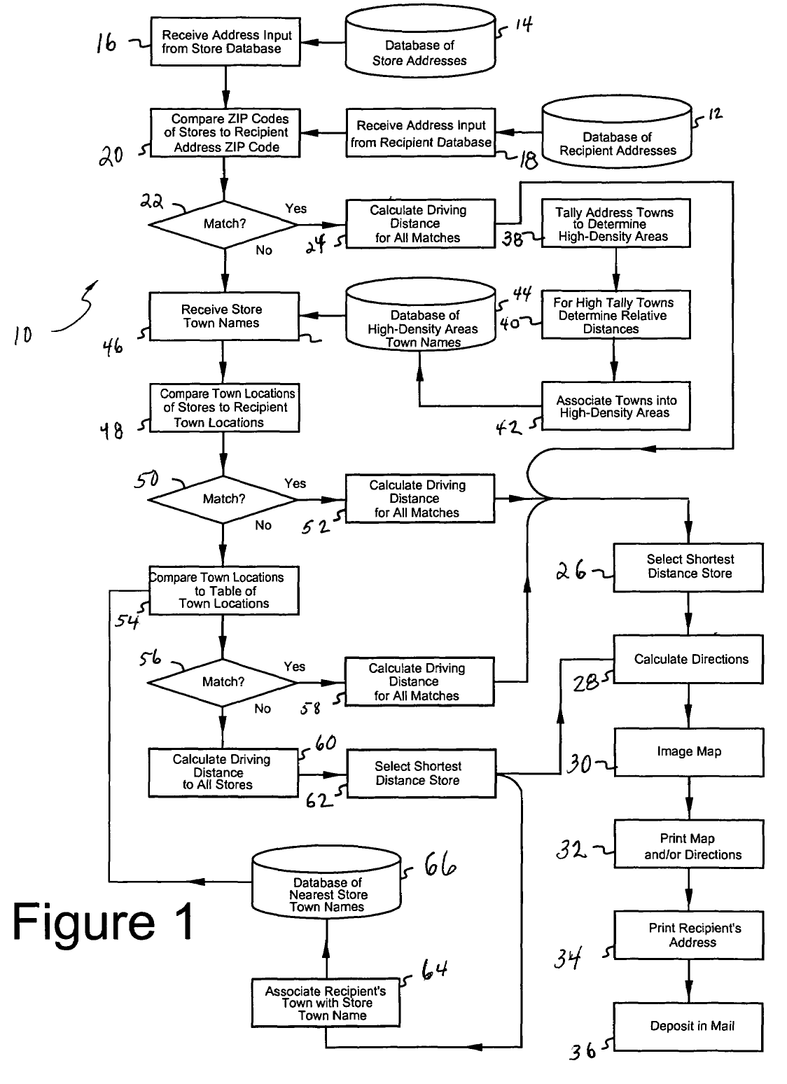

Referring to FIG. 1, software implementing the method 10 of the invention and for employment in the inventive system may be understood.

Initially, a database 12 of, for example, home (or office) addresses of recipients of a particular mailing is provided to the system. Also provided to the system is a database 14 of store addresses for the particular, for example, retail store, medical practice or the like. Retail locations from database 14 are received into the system at step 16. The addresses of persons who are to receive the direct-mail piece are received into the system at step 18.

The addresses may be compared using any suitable algorithm aimed at reducing machine time. Alternatively, the addresses may simply be used to generate a map and/or directions, both of which are intended to guide a recipient walking on foot or driving in a car from his home address to the retail establishment address, for inclusion in a direct-mail piece.

In accordance with a particularly preferred embodiment of the invention, at step 20, the addresses are compared to see if the addresses are in the same ZIP code. If they are and this is determined at decision step 22, it indicates that the driving directions are relatively short, and relatively customized, as compared to driving directions for other recipients and, accordingly, the system proceeds to step 24 where the driving distance or drive time for all stores in the matching ZIP code are calculated.

The system then proceeds to step 26, where the store with the shortest driving distance or drive time is selected. The system then calculates directions at step 28 and images the map at step 30. Imaging of the map at step 30 is optional and may be replaced or be in addition to the calculation of directions.

The system then prints at step 32 on a particular item of advertising, for example a catalog, the map and/or directions. At step 34 the recipient's address is also printed on the same catalog before it is deposited in the mails. The catalog may then be deposited in the mails at step 36.

At step 38, the system tallies the number of instances each town in the recipient address database 12 occurs. This is used to determine high density areas, which are defined as towns having a minimum number of recipients. At step 40, the system calculates distances between high-density towns and all the stores in database 14. The towns are then associated into high-density areas, keyed to store locations at step 42. This information is then ported to database 44.

If there is no match of zip codes at step 22, town names in high density areas are received at step 46. This information is used at step 48 to determine whether a particular town associated with a particular address is close to a particular store. This determination is made at step 50. If the determination is positive, the driving distance for all matching stores is calculated at step 52. The system then proceeds to step 26 where the shortest distance store is selected and then proceeds to step 36 where the advertising item, such as the catalog, is printed with a map and/or directions and the address of the recipient for deposit in the mails at step 36.

If there is no match between the town locations of stores and the recipient's town location, at step 54, the system compares to town locations of the recipients to a table of town locations which is generated as detailed below. If there is a match, at step 56 the system proceeds to step 58 where the driving distance for all matches in town names is calculated, after which the system proceeds to step 26 to select the shortest distance and generate the mailing piece as described above.

If there is no match at step 56, a brute force approach involves the calculation of driving distances for all stores at step 60, the selection of the shortest distance store at step 62 and the calculation of driving directions at step 28. Then as in the previous description, the generation of a mailing piece and deposit in the mails at step 36. In this description, it is noted that references to driving distance or driving time are used interchangeably and depend upon user preference.

The information generated at step 62 also results in a generation of a recipient town location and shortest distance store at a particular town location and this information is put together at step 64 and stored in a database at step 66. This database 66 is used at step 54 to compare town locations to the town locations of the recipients.

As alluded to above, the system many simply proceed from step 22 step 60 in a brute force approach, generating a map and/or directions for every address by comparing each recipient's address to every store location. The shortcut driving time or shortest distance store is then selected and the corresponding map and or directions are printed and a recipient address is also printed. If computing power is sufficient, this is a reasonable way to operate the inventive system. If, however, computing power is limited and the number of stores is great, the above approach may have advantages.

In this description, alternative embodiments of the invention are numbered with numbers which correspond to analogous steps in the prior embodiment plus a multiple of 100.

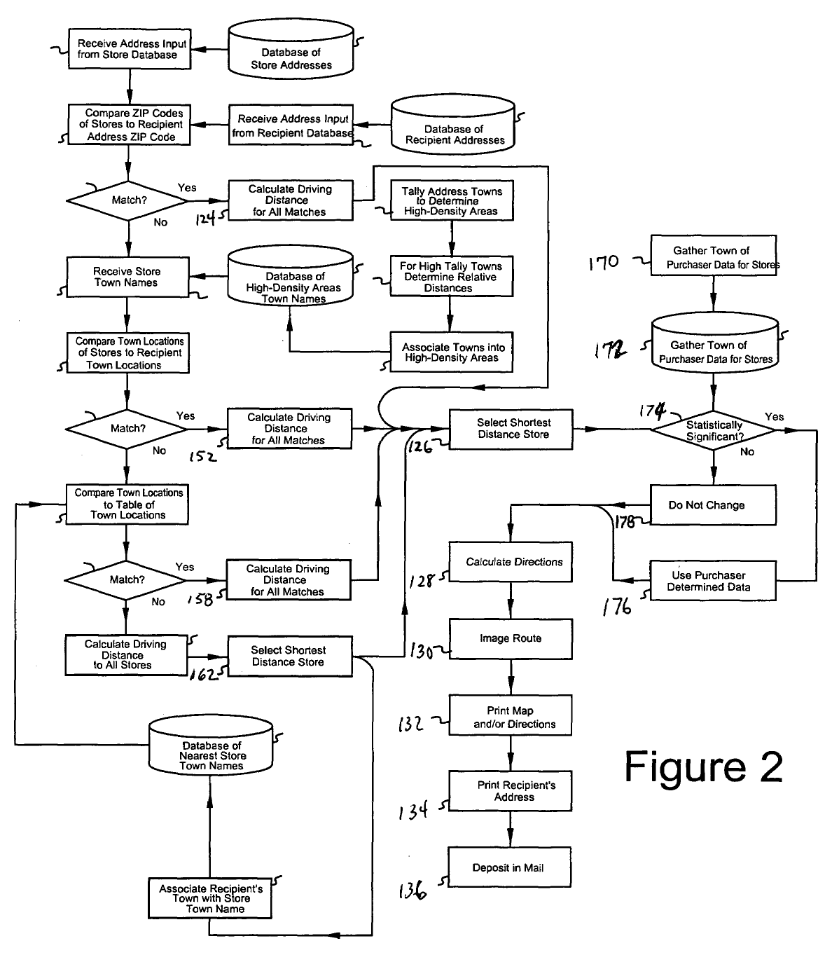

Referring to FIG. 2, an alternative embodiment of the invention is illustrated. The operation of this embodiment is substantially similar to that of the embodiment of FIG. 1. However, after the determination of driving distances at the steps 124, 152, 158, and 162, the system proceeds to step 126 where the shortest driving distance or time is selected. The store selection is then available for comparison as detailed below.

The system also gathers information from the cash registers of the various retail outlets at step 170, and sends the same to a database at step 172. This information is compared at step 174 to the store selected at step 126, and a determination made if the numbers of consumers going to the other store is statistically significant. If the difference is statistically significant, the store selection based on information in database 172 is used. In other words, consumers are sent to stores where their neighbors often go from a statistically significant point of view. This election is made at step 176 and the system then proceeds to calculate corrections, image the route and so forth at steps 128-136, as described above.

If the difference is not statistically significant, at step 178, the system proceeds directly with the selection made at step 126 to calculate directions at step 128 and proceed through step 136 to deposit the printed mail piece in the mails.

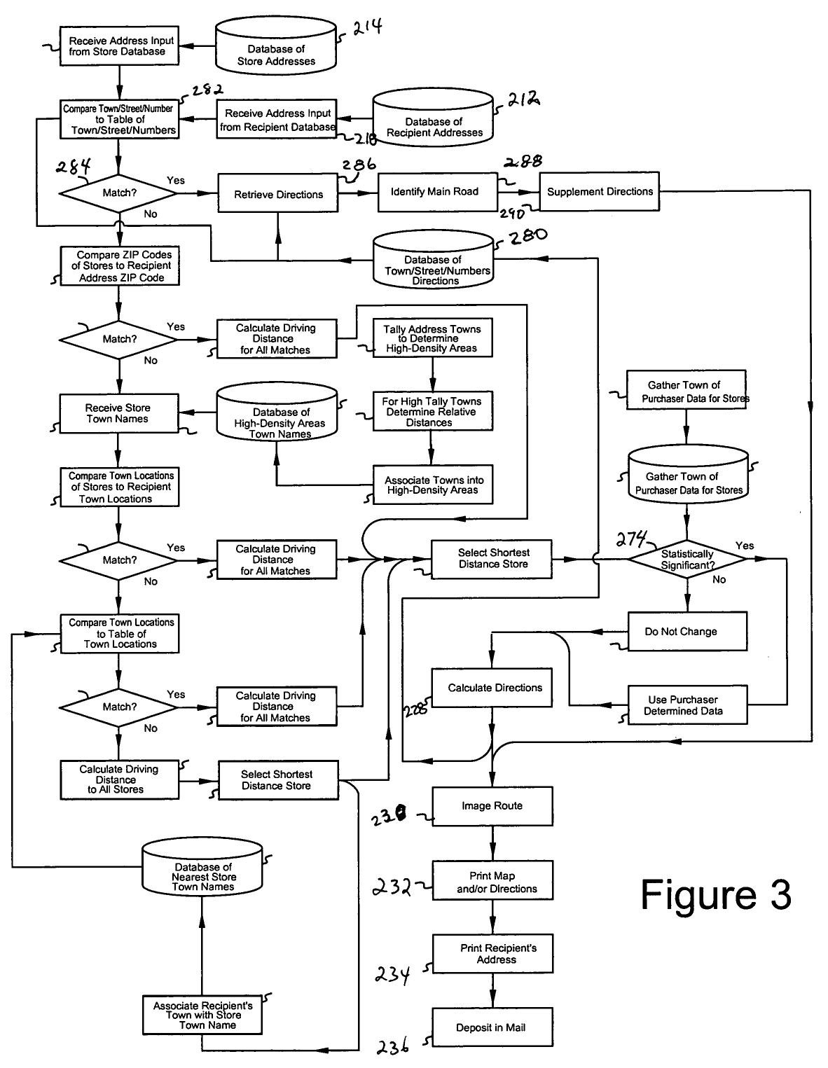

Still yet another alternative embodiment is illustrated in FIG. 3. In this embodiment, information generated by the system at step 274 is used to calculate directions at step 228 and inform a database at step 280. The information in database 280 is a table of town names, street names and numbers associated with a set of directions. After the loading of information from databases 212 and 214, the system compares, at step 282 the town names, street names and street numbers of a recipient address received at step 218 to those in the table of database 280.

If there is a near match at step 284, the system proceeds to retrieve the directions, at step 286 from database 280. The system then proceeds at step 288 to identify a nearest main road and then supplements in the directions by generating supplemental directions at step 290 between the particular recipient's address and the main road. This information is then passed on for imaging of the route and printing of the map and directions at step 230 and eventual deposit in the mails at step 236.

While an illustrative embodiment of the invention has been described, various modifications may be obvious to those of ordinary skill in the art. Such modifications are within the scope of the invention which is limited and defined only by the claims.

1. A method of manufacturing an advertising device, comprising:
a) manufacturing an advertising device describing at least one attribute of at least one product or service;
b) retrieving an facility address from a database of establishment locations the address of one or more facilities offering said product or service;
c) retrieving a recipient address of an intended advertising device recipients from a database of advertising device recipients;
d) determining a route between said facility address and said recipient address; and
e) applying said route to said advertising device.

2. A method of manufacturing an advertising device, as in claim 1, wherein manufacturing an advertising device describing at least one attribute of at least one product or service is a catalog, coupon, gift, brochure, or flyer.

3. A method of manufacturing an advertising device, as in claim 1, wherein said facility address is the address of a retail, professional, medical, legal services, sports, golf course, or gym establishment.

4. A method of manufacturing an advertising device, as in claim 1, wherein previously determined routes are consulted before calculating a route for the purpose of eliminating calculation of a route or shortening the time for calculation of a route.

5. A method of manufacturing an advertising device, as in claim 1, wherein a driving route between said facility address and said recipient address is determined.

6. A method of manufacturing an advertising device, as in claim 5, wherein said application is done by direct printing.

7. A method of manufacturing an advertising device, as in claim 5, wherein said application is done by printing on a label which is adhered to said advertising device.

8. A method of manufacturing an advertising device, as in claim 1, wherein said applying said route, comprises applying said route in map form or as a set of driving directions.

9. A method of manufacturing an advertising device, as in claim 1, further comprising the step of depositing in the mails said advertising device with said route applied to it.
